(19) United States
(12) Patent Application Publication
(10) Pub. No.: US 2012/0305479 A1
(43) Pub. Date: Dec. 6, 2012

(54) MIXED SUBSTRATES FOR ANAEROBIC BIOREMEDIATION IN AQUIFERS

(76) Inventors: David Falatko, South Portland, ME (US); Sami A. Fam, Dover, MA (US)

(21) Appl. No.: 13/150,687

(22) Filed: Jun. 1, 2011

(51) Int. Cl. C02F 3/28; C02F 101/16; C02F 101/10; C02F 103/06; C02F 101/36

(52) U.S. Cl. 210/610

(57) ABSTRACT

A method for the in-situ biological remediation of groundwater contaminated with halogenated organic compounds, heavy metals, various inorganic compounds, nitrate, and other compounds which can be reduced into less harmful by-products under anaerobic conditions through the application and distribution of a water-soluble microbial substrate mixture consisting of alcohol, carboxylates, and glycerol in an alkaline solution. The method delivers and distributes a substrate mixture into impacted groundwater zones using different mixture proportions based on aquifer conditions so as to optimize distribution in the aquifer. Acclimated microbes and nutrients are also added as needed.

### BACKGROUND OF THE INVENTION

1. Field of the Invention

The invention involves the remediation of groundwater contaminated with compounds that can be degraded or altered into less harmful forms under anaerobic conditions that are developed when a mixture of biologically degradable carbon substrates are added and distributed within a targeted treatment zone. The substrate mixture provides compounds with varying molecular weight, subsurface mobility, and half-lives to ensure a large treatment zone; the substrate mixture is inhibitory to microbes at high concentrations so it can be used to control microbial growth at the injection points; the substrate mixture contains pH buffers to maintain neutral pH after dilution in groundwater; the substrate produces less acid during its degradation than other substrates; and, the substrate compounds are efficient producers of hydrogen for reductive processes.

2. Description of the Prior Art

Industrial processes and releases of chemicals to the environment over the years have resulted in groundwater impacted with a wide variety of contaminants such as halogenated organic compounds including chlorinated aliphatic hydrocarbons (CAH), petroleum hydrocarbons, heavy metals, and inorganic compounds with human health effects such as nitrate and perchlorate. The most common method to deal with these impacts was to pump the groundwater out of the ground, treat it above-grade, then re-inject it back into the aquifer or discharge the treated water to the surface. For many of the targeted contaminants, the extraction and treatment process often simply transferred the contaminants from one media to another. For example, in the treatment of volatile organic compounds (VOCs), they would typically be volatilized from groundwater with an air stripping process and transferred to the atmosphere or to an adsorptive media, such as granular activated carbon. In the case of dissolved metals, they would be extracted with groundwater, then oxidized, precipitated from solution, and collected as a sludge that then had to be dewatered and disposed of as a hazardous material. Treatment of nitrate or perchlorate typically involved the extraction of groundwater with above-grade treatment using various methods such as ion exchange, reverse osmosis, or anaerobic bio-reactors. In all of these cases, groundwater extraction and above-grade treatment is a costly and slow method to address large areas of impacted aquifers.

Continued advances in remediation of impacted groundwater focused more on the treatment of these contaminants within the aquifer (in-situ) with an emphasis on bioremediation to either degrade the contaminants in-situ or alter them to less harmful forms. In-situ bioremediation of these contaminants focused on altering the subsurface conditions to enhance microbial growth for either aerobic or anaerobic conditions. Aerobic conditions were found to be suitable for the biological degradation of petroleum hydrocarbons and could be created with the addition of oxygen to the subsurface. Anaerobic conditions were found to be suitable for the biological degradation of CAHs and the chemical reduction of oxidized metals and other inorganics such as nitrate and perchlorate. Significant effort and research was involved in establishing and applying the processes for biological degradation of CAHs due to their toxicity and prevalence in groundwater.

Anaerobic conditions are established in groundwater when microbial growth occurs, and energy is produced when degradable carbon substrates are oxidized and electron acceptors are reduced. In this manner microbes eat the carbon substrate as food, and breath or respire with electron acceptors such as oxygen, then use alternative electron acceptors in place of oxygen once oxygen is no longer present. These alternate electron acceptors are used based on the energy they yield, oxygen yields the most energy so it is used up first, then alternate electrons acceptors are used sequentially in the following order: nitrate, manganese, iron, sulfate, and carbon dioxide to produce methane. The following equations show the reduction of the electron acceptors with hydrogen as the electron donor for simplicity; hydrogen is produced as an end product during degradation of carbon substrates under anaerobic conditions.

2H₂+O₂→2H₂O (aerobic respiration with oxygen reduction)

2H⁺+5H₂+2NO₃⁻→N₂+6H₂O (nitrate reduction)

2H⁺+H₂+MnO₂→Mn²⁺+2H₂O (manganese oxide dissolution and reduction)

4H⁺+H₂+2FeOOH→2Fe²⁺+4H₂O (iron oxide dissolution and reduction)

H⁺+4H₂+SO₄²⁻→HS⁻+2H₂O (sulfate reduction)

4H₂+CO_{2(gas)}→CH_{4(gas)}+4H₂O (carbon dioxide reduction and methanogenesis)

Various degrees of anaerobic conditions may be needed for groundwater remediation, depending on what compounds need to be reduced, with remediation of CAHs occurring in the range of sulfate reduction and methanogenesis.

With the increasing awareness of anaerobic processes for groundwater remediation came increased application of the enhanced anaerobic dechlorination (EAD) process for in-situ biodegradation of CAHs in groundwater including tetrachloroethene (PCE), trichloroethene (TCE), and trichloroethane (TCA). Anaerobic dechlorination occurs when bacteria utilize CAHs for respiration as alternate electron acceptors under anaerobic conditions in place of oxygen or other terminal electron acceptors, a process called halorespiration. This dechlorination process occurs naturally if anaerobic conditions and the requisite microorganisms are present in the subsurface, or it can be enhanced in the subsurface with the introduction of biologically degradable carbon substrates.

Dechlorination typically occurs under sulfate reducing and methanogenic conditions, when other electron acceptors are scarce and the energy yielded by halorespiration is more favorable. Dechlorination occurs first for the most heavily chlorinated compounds, with PCE being degraded with the substitution of one chloride ion with one hydrogen ion to form TCE. Dechlorination proceeds sequentially in the same manner through TCE to cis-1,2-dichloroethene (DCE), to vinyl chloride (VC), and then to ethene. Each step in the dechlorination process requires one mole of hydrogen per mole of chlorine and yields one mole of hydrochloric acid (HCl), such that one mole of PCE yields four moles of HCl with complete dechlorination. 1,1,1-TCA follows a similar dechlorination sequence also.

The reactions for reductive dechlorination are typically considered to use hydrogen (H₂) as the electron donor and CAHs as the electron acceptor as shown:

4H₂+C₂Cl₄→C₂H₄+4HCl (PCE reduced w/hydrogen to ethene and hydrochloric acid)

3H₂+C₂HCl₃→C₂H₄+3HCl (TCE reduced w/hydrogen to ethene and hydrochloric acid)

2H₂+C₂H₂Cl₂→C₂H₄+2HCl (DCE reduced w/hydrogen to ethene and hydrochloric acid)

H₂+C₂H₃Cl→C₂H₄+HCl (VC reduced w/hydrogen to ethene and hydrochloric acid)

3H₂+C₂H₃Cl₃→C₂H₆+3HCl (TCA reduced w/hydrogen to ethane and hydrochloric acid)

2H₂+C₂H₄Cl₂→C₂H₆+2HCl (DCA reduced w/hydrogen to ethane and hydrochloric acid)

It is apparent from these equations that dechlorination requires significant amounts of hydrogen produced from the anaerobic fermentation of organic carbon substrates, and dechlorinating high concentrations of CAHs can cause significant alkalinity demand or a sharp drop in pH if sufficient buffering capacity is not present. Viability of microbial cultures capable of dechlorination is very pH-dependent, and complete dechlorination has been shown to slow significantly at a pH below 6.0-6.3.

Anaerobic conditions are also suitable for the precipitation of various metals when sulfate is present and anaerobic conditions sufficient for sulfate reduction are established. The addition of carbon substrates to the subsurface to enhance microbial growth and anaerobic conditions promote sulfate-reducing bacteria to produce sulfide ions which then combine with reduced forms of various metals. Anaerobic fermentation to produce hydrogen acts to reduce sulfate in the absence of other more easily reduced compounds as shown:

4H₂+SO₄²⁻→S²⁻+4H₂O (sulfate reduced w/ hydrogen to sulfide and water)

The sulfide ions then combine with reduced forms of various metals such as lead (Pb), zinc (Zn), arsenic (As), nickel (Ni), cadmium (Cd), and mercury (Hg) to form metal sulfides as shown:

Pb²⁺+S²⁻→PbS_{(solid)}

Zn²⁺+S²⁻→ZnS_{(solid)}

2AS³⁺+3S²⁻→As₂S_{3(solid)}

Ni²⁺+S²⁻→NiS_{(solid)}

Cd²⁺+S²⁻→CdS_{(solid)}

Hg²⁺+S²⁻→HgS_{(solid)}

These metal sulfide compounds formed under the sulfate reducing conditions are insoluble precipitated solids that are stable in groundwater and no longer migrate with groundwater flow.

Anaerobic conditions are also suitable for the removal of nitrate, a process called denitrification, where nitrate is reduced to form nitrogen gas and water, and the reduction of perchlorate to form chloride ion and water as shown:

2H⁺+5H₂+2NO³⁻→N_{2(gas)}+6H₂O (nitrate reduced w/hydrogen to nitrogen gas and water)

4H₂+ClO₄⁻→Cl⁻+4H₂0 (perchlorate reduced w/hydrogen to chloride ion and water)

It has been established and is clear from the above equations that a wide variety of contaminants can be biologically degraded, immobilized, or rendered less harmful under anaerobic conditions. Establishing the anaerobic conditions needed for indigenous populations of microbes to prosper with the proper amounts and types of degradable carbon substrate is the greatest challenge in enhancing these processes and remediating impacted groundwater. The typical established methods utilized for delivery of degradable organic substrates include placement of stationary phase substrates such as oil, emulsified oil, or lactate-based polymers, and batch placement of dilute solutions of liquid phase substrates such as molasses, corn syrup, or whey.

The stationary substrates can last a long time in the subsurface and can establish anaerobic conditions where they are placed, but they cannot migrate with groundwater flow in the subsurface and therefore need numerous injection points and large volumes to properly place the substrates to get full coverage over large treatment areas. For this reason they are often used as flow-through treatment “barriers”, and therefore treat groundwater only as fast as it can flow through the area where they are placed. Large areas that took long periods of time to become contaminated will take a long time to be remediated since the rate is dependent on groundwater flow rates. Batch placement of stationary phase substrates also provides no method for adding alkalinity to restore pH to neutral levels after degradation of the substrate produces organic acids and fatty acids and the dechlorination process releases hydrochloric acid, all of which lower pH. For these reasons there is considerable effort and expense required to properly place the solid phase so it can treat the entire targeted area and then maintain suitable conditions after placement.

In the use of oil as a substrate, it is difficult and expensive to emulsify oil to the proper consistency and droplet size to allow it to enter the pores of the aquifer. The large molecular weight (typically 800-1000 grams/mole) and size make it difficult to properly emulsify and inject oil into fine-grained aquifer formations. Aquifers are by nature an efficient filtration media, and tend to remove even the finest particles or oil droplets from emulsified oil in water. Oil droplets in emulsified oil mixes cannot be easily added to low permeability fine-grained aquifers, and once added, it is difficult to establish where the oil went or how far it may have traveled. Oils alone are often not able to initiate substantial microbial growth in short timeframes and a secondary substrate, such as lactate or other simple substrate is needed to get a microbial population established. The greatest advantage that oil offers for development of in-situ anaerobic conditions is that it is slow to degrade in the subsurface and can provide a long-term carbon substrate to sustain biological growth and maintain anaerobic conditions over long periods of time.

The typical liquid phase soluble substrates (molasses, corn syrup) can be added to fine-grained aquifers in dilute form and can travel with groundwater flow to treat larger aquifer areas, but they degrade rapidly and produce significant amounts of carbon dioxide gas which can cause gas blockage of the aquifer and, when dissolved, sharply lower groundwater pH which inhibits biological activity. In addition, rapid degradation of the soluble substrates result in rapid microbial growth which can cause significant fouling and clogging of the injection well by cell mass where it is added, making subsequent injections slow and thereby requiring frequent well cleaning. The rapid degradation of simple soluble substrates also requires that they be added frequently or continuously to the aquifer in order to maintain anaerobic conditions downgradient from the addition point.

### SUMMARY OF THE INVENTION

The best substrates for anaerobic remediation of groundwater should: be easily injected into various types of aquifer materials (coarse and fine grained); be water soluble to allow for easy placement and distribution within the aquifer; not produce excessive amounts of carbon dioxide gas and associated acidity; contain buffering capacity to maintain neutral pH conditions; efficiently produce hydrogen for reduction of the target contaminants; have slow to moderate rates of degradation which allow it to remain in the aquifer for long periods of time; and, be of low cost.

Proper selection of the substrate to use for a particular application is based on cost, ease of use, in-situ degradation rate or half-life, and hydrogen yield when fermented under anaerobic conditions. The theoretical hydrogen yield and acid-generating potential of various substrates can be estimated for comparison purposes to partially evaluate the relative benefit of one substrate over another. Some examples of fermentation reactions and associated hydrogen yield are as shown:

Ethanol: C₂H₆O+5H₂O→2HCO₃⁻+2H⁺+6H₂

Methanol: CH₄O+2H₂O→HCO₃⁻+H⁺+3H₂

Fructose/glucose (molasses): C₆H₁₂O₆+12H₂O→6HCO₃⁻+6H⁺+12H₂

Sucrose/lactose (whey): C₁₂H₂₂O₁₁+25H₂O→12HCO₃⁻+12H⁺+24H₂

Linoleic acid (fatty acid from soy oil): C₁₈H₃₂O₂+52H₂O→18HCO₃⁻+18H⁺+50H₂

Glycerol (from soy oil): C₃H₅(OH)₃+6H₂O→3HCO₃⁻+3H⁺+7H₂

In the case of soy oil, a triglyceride, three linoleic acids and glycerol are used to represent the makeup of the triglyceride of the soy oil, although vegetable oils are made up of various fatty acids besides linoleic acid.

These equations show that the highest theoretical yield of hydrogen on a weight basis is from linoleic acid (0.36 grams H₂/gram), followed by ethanol (0.26 grams H₂/gram) and methanol (0.19 grams H₂/gram), and the lowest is from fructose/glucose (0.13 grams H₂/gram).

These equations also show that the lowest acid-producing fermentations are from ethanol and methanol, which produce one mole of acid for each three moles of hydrogen produced. The highest rates of acid production are from sugars in molasses and whey fermentations, which produce one mole of acid for each two moles of hydrogen produced.

A comparison of these substrates based on typical costs and hydrogen yield indicates that methanol and then ethanol are typically the least expensive in terms of cost per pound of hydrogen produced. Straight, non-emulsified soy bean oil is more expensive, at about twice the price of methanol when compared on a cost per pound of hydrogen produced. Emulsified oil, which is typically needed if oil is to be injected into an aquifer, has to be highly processed and handled in shear mixers with emulsification additives, and is therefore the most expensive, at approximately ten times the cost of methanol on a cost per pound of hydrogen comparison.

It is an objective of this invention to provide a substrate mixture optimized for in-situ anaerobic bioremediation of impacted groundwater when using a groundwater recirculation system consisting of extraction and injection wells. The substrate mixture has characteristics of both the stationary and soluble substrates but is optimized for injection into aquifers when using a groundwater recirculation system to deliver and distribute the substrate. This substrate mixture is comprised of alcohol, potassium carboxylates, and glycerol in an alkaline solution. This mixture is produced when soybean oil (or other liquid vegetable oils), potassium hydroxide (KOH), and alcohol (ethanol, methanol, or other alcohol) are mixed together to hydrolyze the triglycerides which make up the oil to form water-soluble carboxylates (salts of fatty acids) and glycerol in the alcohol. In this reaction, it takes three moles of KOH to react with one mole of triglyceride. This process breaks down the triglyceride into its two main parts, fatty acids and glycerol, while also adding three moles of base per mole of oil to buffer pH, and produces a water-soluble mixture which can be easily injected and distributed within the subsurface.

This mixture has the following benefits for in-situ anaerobic bioremediation of groundwater:
1) High-strength substrate provides significant energy for microbial growth with a high hydrogen yield per mass of substrate at low cost with a slow degradation rate that results in a long half-life in the subsurface.
2) The mixture is water soluble (not emulsified) and is easily added to fine-grained aquifer formations (without consideration of emulsified oil droplet size) which results in good distribution away from injection well and to downgradient locations.
3) The mixture can be altered to provide higher or lower viscosity, depending on the nature of the aquifer in which it will be applied. It can be mixed to provide higher viscosity with more carboxylates and glycerol relative to the alcohol concentration for use in coarser-grained formations with high groundwater velocities. It can be mixed for a lower viscosity with more alcohol relative to carboxylates and glycerol for use in finer-grained formations with low groundwater velocities.
4) The carboxylates are water soluble salts of fatty acids, and contain hydrophilic and hydrophobic ends and are considered surface active agents (surfactants), which are simple soaps and act to solubilize and desorb low-solubility chlorinated solvents from the aquifer matrix and promote faster removal and flushing of impacted areas and overall faster biodegradation.
5) The mixture can also be varied by lowering the amount of potassium hydroxide added relative to oil to produce a mixture that when added to water provides a diluted mixture of emulsified oil, alcohol, carboxylates, and glycerol in water. Under-dosing the potassium hydroxide relative to the amount of oil present produces carboxylates, but also leaves some oil present. The emulsion occurs because the carboxylates form micelles around oil droplets and act to dissolve the insoluble oil into water forming an emulsion of oil in water. Adding an emulsified oil component to the mixture provides a mixture that has a stationary phase additive and could be used in coarser-grained aquifer formations with high groundwater velocities.
6) The carboxylates will neutralize acidity such as from hydrochloric acid produced during the dechlorination process, and will then precipitate out of solution, providing an adsorbed substrate for long-term support of anaerobic microbial growth.
7) Alcohol in the mixture is inhibitory to microbial growth at high concentrations and therefore limits biological fouling of injection wells and promotes microbial growth over larger areas away from the injection wells.
8) The mixture contains alkalinity in the form of the added potassium hydroxide to buffer pH and maintain optimal conditions for microbial growth needed for dechlorination.
9) Unlike carbohydrate solutions (such as molasses) often used in anaerobic in-situ processes, the mixture produces much lower amounts of carbon dioxide and associated acidity which can gas-clog the aquifer and lower pH.
10) The mixture is a low cost alternative that is simple to make either in the field for immediate use or in a manufacturing facility for later use and does not require any specific emulsification mixers or other specialized equipment or operations.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a plan view of the invention applied at a site;

FIG. 2 is a sectional view illustrating applying the decontaminating system at a site with both the underground and above-ground portions shown;

FIG. 3 is equations for the production of the carboxylates and glycerol from vegetable oil (triglycerides); and

FIG. 4 is a plot of data from a test of the process showing desorption and degradation of CAHs with time after substrate addition under anaerobic conditions using the invention substrate mixture.

### DETAILED DESCRIPTION OF THE INVENTION

The invention is directed to a process for making and applying a degradable substrate mixture to quickly and effectively establish anaerobic conditions in contaminated groundwater for bioremediation of CAHs with reductive dechlorination, precipitation of oxidized metals as metal sulfides, and reduction of inorganics amendable to anaerobic remediation such as nitrate and perchlorate. The degradable substrate formulation buffers pH and helps reduce biological fouling in injection wells.

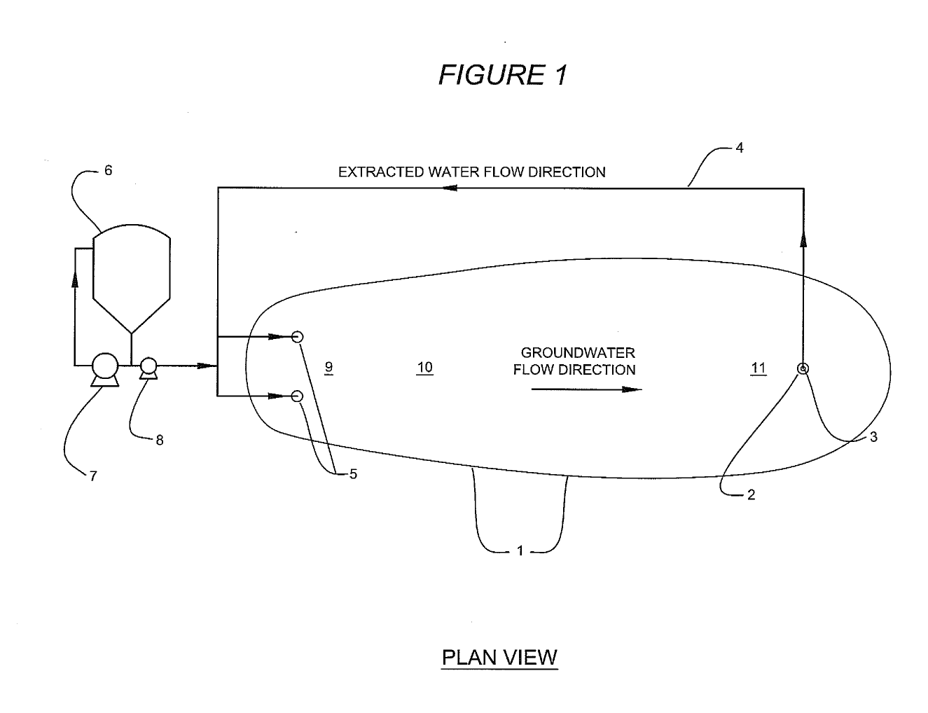

FIG. 1 shows a plume of contaminated groundwater 1 consisting of CAHs, dissolved metals, or inorganics such as nitrates and perchlorate which is targeted for remediation. Extraction well(s) 2 or other groundwater extraction structures are installed at the downgradient end of the targeted remediation area and groundwater is pumped out with well pump 3 and transferred within piping or conduits 4 placed above or below-grade and connected to injection wells 5 or other injection structures installed at the upgradient end of the targeted remediation area 9. A substrate mixture is made in substrate tank 6 by adding proper amounts of the ingredients and mixing with mix pump 7; alternatively, the substrate is mixed off-site and delivered to the treatment area. The substrate mixture consists of alcohol, vegetable oil and potassium hydroxide in ratios suitable to produce a water-soluble mixture in alkaline solution. The alcohol may be ethanol, methanol, isopropyl alcohol or other suitable alcohols. The vegetable oil may be soybean oil, canola oil, corn oil, sunflower oil, olive oil, waste mixed vegetable oils, and peanut oil. The substrate mixture ingredients are combined in ratios based on the stoichiometry of the reaction for a water-soluble mixture, or altered to produce a similar mixture with an emulsified oil component. The mixing apparatus is typically a tank of a size suitable to hold the total additive volume with space for adequate mixing.

The substrate is injected into piping 4 leading to the injection wells using feed pump 8 and substrate is either injected in high concentration batches to inhibit biological growth, or is fed continuously or pulsed intermittently and diluted within the pipeline as it mixes with groundwater and flows into injection wells 5. The piping and mixing pump is capable of rapid mixing of the substrate mixture ingredients. The extracted and now substrate-amended groundwater is then re-injected into injection wells 5 located at the upgradient end of the impacted area targeted for remediation. The amended groundwater injected at the upgradient end of the impacted area 9 now has significant amounts of degradable carbon substrate present and the alcohol content limits biological growth and clogging of the wells due to biomass. The amended groundwater is diluted as it flows away from the injection wells and mixes with non-amended groundwater 10 providing a degradable carbon substrate that enhances biological growth and the development of desirable anaerobic conditions. The minimum concentration of alcohol needed in the injected substrate mixture to inhibit biological growth and fouling of the injections well(s) or other structures is at least 10% by volume. As the amended groundwater moves closer, as shown at 11, to extraction wells 2, the substrate has been almost fully degraded and groundwater from this location is extracted and pumped to injection wells 5 where it is amended with substrate and recirculated into treatment area 1 and the cycle repeated.

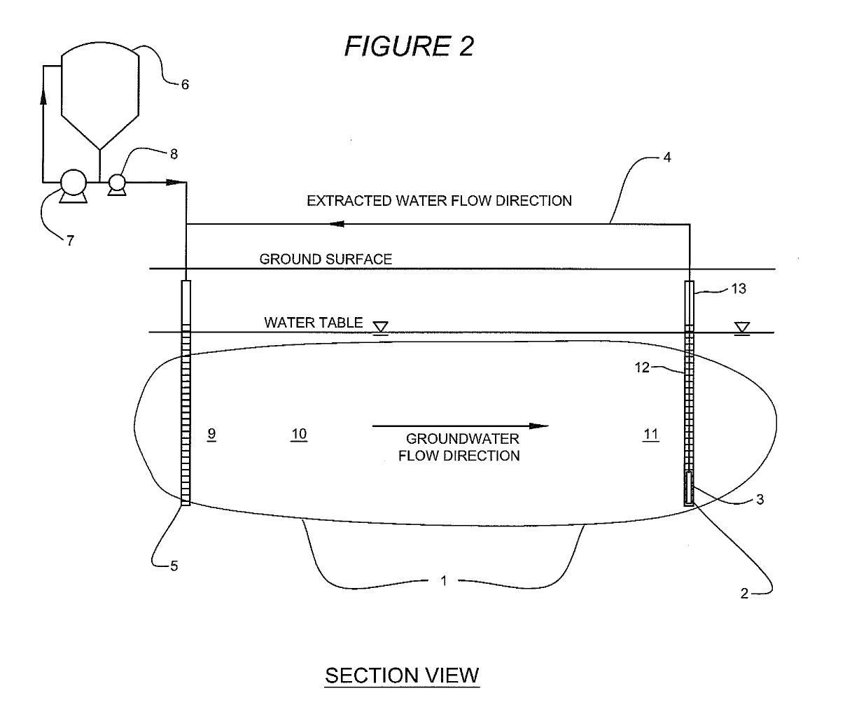

FIG. 2 shows a sectional view of the present invention operating in the same manner as described for FIG. 1. Groundwater is drawn into extraction well 2 through well screen 12 under gradients induced by well pump 3 where it is then pumped up through transfer piping 4 through a section of solid well casing 13 and toward the injection well 5 where it is re-injected into groundwater zone 9 with substrate amendments added. The total number, location, and depths for extraction and injection wells or other extraction and injection structures are selected at each individual site to extract and inject impacted water across the full width, length, and thickness of the impacted area within a limited timeframe. This timeframe is based on the substrates used and their associated half-life in the subsurface. The substrates should be almost completely degraded in the time it takes for the injected groundwater to travel from the upgradient injection locations 9 and 10 to the downgradient extraction locations 11, and the residual concentration of substrate present in groundwater at the extraction wells should be sufficient to create an oxygen demand large enough to inhibit aerobic biological growth in the extracted groundwater. This groundwater travel time from the injection location to the extraction location is typically in the range of a maximum time of between 100 to 500 days, and is also the time it should take to turn over one pore volume of groundwater from the impacted area targeted for remediation. This guideline indicates minimum extraction and injection rates required for proper anaerobic conditions to be established and provides sufficient time for biological reactions to occur. For example, a treatment area containing one million gallons of water needs to have a continuous recirculation rate of approximately 3 gallons per minute to achieve a turn-over time of approximately 250 days. Recirculating groundwater at rates higher than this to provide shorter turn-over times closer to 100 days is preferred, and allows for faster treatment. The unique water soluble, low-fouling, high-strength, pH-neutral substrate of this invention combined with high rates of groundwater recirculation can quickly develop in-situ anaerobic conditions and facilitate rapid site remediation.

The impacted aquifer zone between the injection wells 5 and the extraction wells 2 is the biologically active area 1 where anaerobic conditions develop. In the preferred embodiment of the process, treatment of CAH under enhanced anaerobic dechlorination (EAD) occurs when the first four primary electron acceptors have been reduced (oxygen, nitrate, manganese, and iron in accordance with equations presented previously) and sulfate reducing and methanogenic conditions have been established. Development of the indigenous population for the EAD process requires these conditions along with neutral pH and nutrients such as nitrogen and phosphorous. If there is not an indigenous population of dechlorinators present, supplemental microbes would be cultured and a seed population added to develop within the aquifer. The nutrients of nitrogen and phosphorous may also be added if needed to promote biological growth. To neutralize pH levels, pH additives and alkalinity buffers may be added. These include potassium hydroxide, sodium hydroxide, sodium carbonate, calcium hydroxide, magnesium hydroxide, and sodium bicarbonate. Microorganisms such as Dehaolococoides Ethenogenes may also be added to the groundwater.

Substrate addition rates to the recirculating groundwater with feed pump 8 should result in a total organic carbon (TOC) concentration in subsurface groundwater adjacent to the injection location 10 of approximately 10 mg/l to 20,000 mg/l or as needed to develop anaerobic conditions in the area targeted for the development of anaerobic conditions. The substrate addition may be continuous, pulsed, or batch added depending on site conditions, groundwater velocity, and mode of operation. Substrate should be added such that the residual TOC concentration in groundwater at downgradient extraction location 11 adjacent to the extraction well 2 is sufficient to create an oxygen demand large enough to inhibit aerobic microbial growth in the extracted groundwater, or approximately 10-100 mg/l.

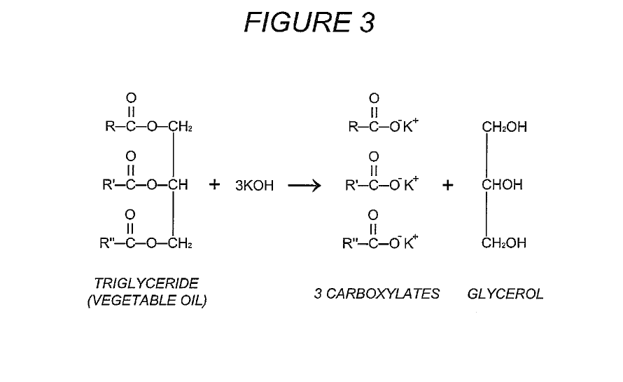

FIG. 3 shows a substrate formula and Table 1 below shows the ingredient ratios to be selected based on site information pertaining to the aquifer conditions. The mixture is made by adding the ingredients to a batch mix tank of sufficient size, and thoroughly mixing all ingredients with mix pump 7 to contact the oil and the potassium hydroxide (KOH) to allow hydrolysis of the oil to produce carboxylates (salts of fatty acid) and glycerol. This can be conducted either on-site or at an off-site system and delivered to the site for later use. An aquifer with coarser-grained materials and a higher groundwater velocity would use a more viscous, higher-strength mixture with more oil and KOH to produce higher levels of carboxylates and glycerol. Emulsified oil components can also be incorporated into the mixture by altering the ratio of oil to KOH to under-dose the KOH and leave some percentage of oil un-reacted. This mixture with the emulsified oil may be suitable for coarser-grained aquifers with high groundwater flow velocities. Often the KOH will be approximately a 50% stock solution or equivalent combination of a lower concentration and increased volume.

TABLE 1

| Alcohol | Soybean | | |
|---|---|---|---|
| (ethanol, | or | | |
| Methanol, or | Vegetable | 50% | |
| other) | Oil | KOH | Comments |
| 39-95% | 4-50% | 1-11% | Use Oil:KOH ratio of 4.5:1 (vol:vol) |
| | | | to produce a fully reacted, water |
| | | | soluble additive, mix thoroughly |
| | | | for at least 30 minutes to |
| | | | homogenize mixture |
| 39-95% | 4-50% | 1-11% | Use Oil:KOH ratio of between 4.5:1 |
| | | | (vol:vol) and 11:1 (vol:vol) mix with |
| | | | an emulsified oil component, mix |
| | | | thoroughly for at least 30 minutes |
| | | | to homogenize mixture |

Fine-grained aquifers with low groundwater velocity would use less oil and KOH to make a lower viscosity mixture. Continuous, pulsed, or batch addition of the mixture to the aquifer with continuous recirculation of groundwater are cost effective methods that provide for the best treatment. Any of these substrate addition modes should be coupled with large volumes of water to distribute the substrates to the targeted treatment areas and dilute the mix in the aquifer.

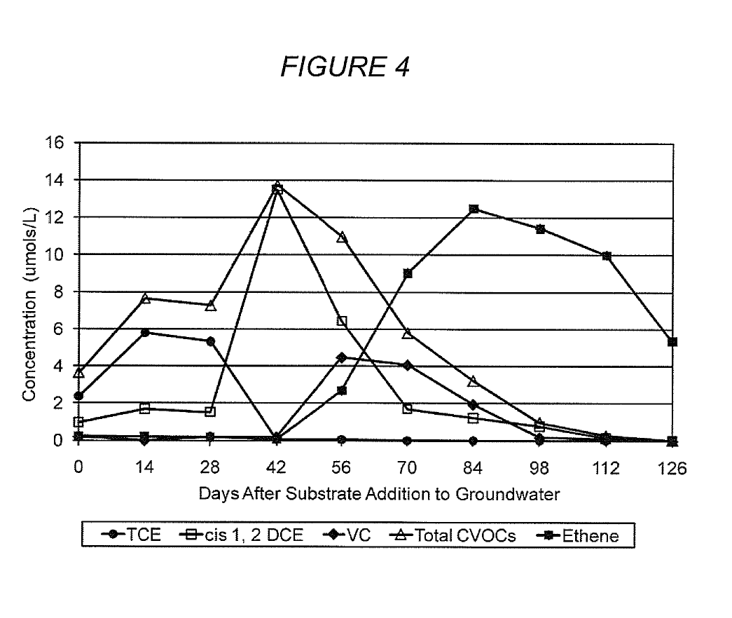

FIG. 4 is a graph showing data from a test for the dechlorination of CAHs in groundwater impacted with TCE. Data from the test indicates that the substrate mixture promoted the initial desorption of TCE from the aquifer materials as indicated by the increase in TCE after addition of the substrate. This allowed for rapid TCE gradation in the dissolved phase, and spurred the production of cis 1,2-DCE, the next degradation by-product in the sequence after TCE. The levels of cis 1,2-DCE increased rapidly, with subsequent degradation of cis 1,2-DCE and production of VC. With generation and subsequent degradation of VC there is then an increase in ethene followed by degradation of ethene as the final step in the EAD process.

Alternatively the invention may include the reduction of nitrate for the process of denitrification, to produce nitrogen gas. The same physical process is implemented as described previously and shown in FIGS. 1-3, but the degree of subsurface anaerobic reducing conditions is not as great as for the EAD process. Aquifer reducing conditions need to only reach nitrate reduction, which occurs just after oxygen is reduced and depleted but before manganese and iron oxides start to be reduced. Another similar embodiment of the invention is the reduction of perchlorate to produce chloride ion. This is functionally the same physical process as described previously and shown in FIGS. 1-3, and occurs under similar reducing conditions as nitrate.

The invention may also include the reduction of sulfate to produce sulfides and precipitate reduced metals out of solution as metal sulfides. The metals potentially removed by this process primarily include divalent cations and were presented previously in background information. This is functionally the same physical process as described previously and shown in FIGS. 1-3.

Another alternative is for the flushing and subsequent biological dechlorination of high concentrations of CAHs where evidence of dense, non-aqueous phase liquids (DNAPL) is present indicating pure CAH solvent is present in the subsurface. High CAH concentrations and CAH solvents are typically inhibitory to microbial growth and can reside in the subsurface for extended periods if not removed, causing continued dissolution of dissolved phase CAH contamination and increasing groundwater contamination. The surfactant and co-solvent effects of the mixture can flush-out and remove the DNAPL and transfer it to the biologically active areas where it can then be degraded.

The preferred embodiment may be altered from as shown in FIG. 1-3 such that other application methods are possible without altering the basic approach. Groundwater extraction and injection could be done on an intermittent or batch basis to recirculate the amendments into the targeted treatment area. Extraction and injection wells, chambers, trenches, pits, sumps, or other structures could be used to extract and inject groundwater to establish groundwater recirculation and distribute the amendments. Addition of the substrate mixture and amendments could be completed on a batch basis, pulsed intermittently, or added continuously in dilute form or diluted with the continuous recirculation of groundwater.

The embodiments herein disclosed are not intended to be exhaustive or to unnecessarily limit the scope of the invention. The embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention.

What is claimed:

1. A method of remediation for degrading, removing, or immobilizing contaminants dissolved in groundwater, said method comprising:
a) providing at least one extraction well or structure extending from a ground surface into a contaminated saturated zone;
b) providing at least one injection well or structure extending from a ground surface into the contaminated saturated zone;
c) providing mixing apparatus and mixing alcohol, vegetable oil, and potassium hydroxide in established ratios to produce carboxylates and glycerol in an alcohol based, water-soluble substrate mixture, or a similar mixture with an emulsified oil component produced by increasing the ratio of oil to potassium hydroxide;
d) adding the substrate mixture, nutrients, and microorganisms to the groundwater by extracting and injecting groundwater to distribute the added materials into a targeted treatment zone to establish anaerobic conditions suitable to degrade, immobilize, or remove from solution a variety of contaminants; and
f) monitoring and maintaining substrate levels for as long as needed to maintain anaerobic conditions in a range appropriate for the degradation, removal, or immobilization of the contaminants which are targeted for treatment in the contaminated saturated zone.

2. The method of claim 1, wherein the at least one extraction and injection well are installed for extraction and injection of impacted groundwater within and across the area targeted for remediation.

3. The method of claim 1, wherein the mixing apparatus is used to process the substrate mixture of alcohol, vegetable oil and potassium hydroxide in ratios suitable to produce a water-soluble mixture in an alkaline solution.

4. The method of claim 3, wherein the alcohol is selected from the group consisting of ethanol, methanol, or isopropyl alcohol.

5. The method of claim 3, wherein the vegetable oil is selected from the group consisting of soybean oil, canola oil, corn oil, sunflower oil, olive oil, waste mixed vegetable oils, and peanut oil.

6. The method of claim 3, wherein the potassium hydroxide is a 50% stock solution or equivalent combination of a lower concentration and increased volume.

7. The method of claim 3, wherein the mixing apparatus is a tank of a size suitable to hold the total additive volume with sufficient space for mixing and piping and mixing pump capable of rapid mixing of the substrate mixture ingredients.

8. The method of claim 3, wherein the substrate mixture ingredients are combined in ratios based on the stoichiometry of the reaction for a water-soluble mixture or altered to produce a similar mixture with an emulsified oil component.

9. The method of claim 1, wherein the substrate mixture is added to the groundwater in either batch, pulsed, or continuous modes in order to enhance biological growth in the subsurface and create anaerobic conditions.

10. The method of claim 1, wherein the degradable carbon substrate mixture is injected into the aquifer and distributed throughout the impacted area targeted for remediation using the at least one extraction and injection well and where substrate concentrations are maintained throughout the targeted treatment area at levels suitable to create and maintain anaerobic conditions in groundwater.

11. The method of claim 10, wherein alcohol is present in the injected substrate mixture and inhibits biological growth and fouling in the well bore and immediately adjacent surrounding areas of the aquifer.

12. The method of claim 10, wherein the substrate concentrations added and established in the groundwater after being injected and distributed in the aquifer around the at least one injection well or injection structure satisfy electron donor demand of the aquifer and establish anaerobic conditions suitable for reducing conditions required for remediation of the target contaminants.

13. The method of claim 10 where target residual substrate concentrations remaining in the groundwater at the downgradient end of the targeted treatment zone are sufficient to create an oxygen demand large enough to inhibit aerobic biological growth in the extracted groundwater.

14. The method of claim 10, wherein the targeted treatment area of the impacted groundwater zone have a natural or induced groundwater velocity across it wherein one pore volume of groundwater within said treatment zone is exchanged within the time required for microbial action to degrade the substrate from the initial injected concentration to the low residual level needed to create an oxygen demand at the extraction wells sufficient to inhibit aerobic microbial growth.

15. The method of claim 1, wherein the contaminants in the aquifer consist of chlorinated or halogenated organic compounds susceptible to anaerobic degradation, inorganic compounds amendable to anaerobic transformation into less harmful compounds or will be removed from groundwater, and soluble metals or other compounds that can be precipitated from solution or immobilized and retained within the aquifer.

16. The method of claim 15, wherein halogenated or chlorinated organic compounds selected from the group consisting of tetrachloroethene, trichloroethene, and 1,1,1-TCA are dechlorinated sequentially to harmless by-products under anaerobic conditions of sulfate reduction and methanogenesis.

17. The method of claim 16, wherein acclimated microorganisms capable of complete dechlorination are cultured to significant populations and added to groundwater and distributed throughout the targeted treatment area of an impacted groundwater zone.

18. The method of claim 16, wherein nutrients such as nitrogen and phosphorous are added in proportion to the carbon loading from the substrate mixture.

19. The method of claim 16, wherein pH additives and alkalinity buffers selected from the group consisting of potassium hydroxide, sodium hydroxide, calcium hydroxide, magnesium hydroxide, sodium carbonate, and sodium bicarbonate are added to neutralize pH levels.

20. The method of claim 15, wherein anaerobic, sulfate reducing conditions result in the production of sulfide and the precipitation of metal sulfides which removes the metals from a dissolved phase and immobilizes them.

21. The method of claim 15, wherein anaerobic, nitrate to manganese oxide reducing conditions results in the reduction of nitrate for denitrification and removal of nitrate from groundwater as nitrogen gas.

22. The method of claim 15, wherein anaerobic, nitrate to manganese oxide reducing conditions results in the reduction of perchlorate, for reduction of perchlorate to chloride ion, a harmless salt in groundwater.

23. The method of claim 1, wherein high concentration of chlorinated aliphatic hydrocarbons or dense, non-aqueous phase liquids indicative of pure chlorinated aliphatic hydrocarbons solvents can be removed by flushing with solutions of the substrate mixture which acts as a co-solvent and then provides significant substrate for continued biological growth.

24. The method of claim 1, wherein the viscosity of the substrate mixture is altered to provide a higher or lower viscosity, depending on the nature of the water in the treatment zone.

25. The method of claim 24, wherein the substrate mixture provides a higher viscosity with more carboxylates and glycerol relative to the alcohol concentration for use in coarser-grained formations with high groundwater velocities.

26. The method of claim 24, wherein the substrate mixture provides a lower viscosity with more alcohol relative to carboxylates and glycerol for use in finer-grained formations with low groundwater velocities.
